(19) United States
(12) Patent Application Publication
(10) Pub. No.: US 2026/0152181 A1
(43) Pub. Date: Jun. 4, 2026

(54) SYSTEM AND METHOD FOR CONTROLLING TOW MODE OF ECO-FRIENDLY VEHICLE

(71) Applicants: HYUNDAI MOTOR COMPANY, SEOUL (KR); KIA CORPORATION, SEOUL (KR)

(72) Inventor: Hyeong Seok Yang, Hwaseong-si (KR)

(73) Assignees: HYUNDAI MOTOR COMPANY, SEOUL (KR); KIA CORPORATION, SEOUL (KR)

(21) Appl. No.: 19/251,192

(22) Filed: Jun. 26, 2025

(30) Foreign Application Priority Data
Nov. 29, 2024 (KR) 10-2024-0174306

(51) Int. Cl. B60W 30/18; B60W 10/18; B60W 10/20

(52) U.S. Cl. CPC B60W 30/18009; B60W 10/18; B60W 10/20; B60W 2556/65

(57) ABSTRACT

A method for controlling a tow mode of an eco-friendly vehicle detects whether an abnormality occurs in a connector connected between a tow vehicle and a towed vehicle to enable towing and communication therebetween using various sensors, warns the driver of an abnormality in the connector based on the detection result, and induces an emergency stop of the vehicle through control that applies a braking torque to the towed vehicle in addition to the tow vehicle, thereby preventing a safety accident of the vehicle due to an abnormality in the connector in advance.

### CROSS REFERENCE TO RELATED APPLICATIONS

This application claims under 35 U.S.C. § 119(a) the benefit of priority to Korean Patent Application No. 10-2024-0174306 filed on Nov. 29, 2024, the entire contents of which are incorporated herein by reference.

### BACKGROUND

### (a) Technical Field

The present disclosure relates to a method of controlling a tow mode of an eco-friendly vehicle, and more specifically, to a system and method for controlling a tow mode of an eco-friendly vehicle that can induce an emergency stop of a vehicle when a problem occurs in a connector that is connected between a tow vehicle and a towed vehicle to enable towing and communication therebetween.

### (b) Background Art

As it is well known, eco-friendly vehicles include hybrid vehicles that use engines and motors as driving sources, electric vehicles that use motors as driving sources, and fuel cell vehicles.

For an owner of two or more vehicles for different purposes of eco-friendly vehicles, when it is desired or necessary to use all of the vehicles at a desired destination, the owner can take all the two or more vehicles to the desired destination using a towing function.

For example, by designating one vehicle as a tow vehicle that actually drives, and other vehicles as towed vehicles that are connected to a rear side of the tow vehicle by a predetermined towing device, all the two or more vehicles can be taken to the desired destination.

FIG. 1 is a schematic diagram illustrating a conventional towing charging mode.

As shown in FIG. 1, in order for a tow vehicle 100 to tow a towed vehicle 200 to a destination, the tow vehicle 100 and the towed vehicle 200 are connected to enable towing and communication therebetween through a connector 300.

To this end, the tow vehicle 100 and the towed vehicle 200 may be connected to enable towing and communication therebetween by the connector 300 including a cable for controller area network (CAN) communication, and a vehicle controller of the tow vehicle 100 and a vehicle controller of the towed vehicle 200 may be connected to enable data transmission and reception by the cable for the CAN communication included in the connector 300.

Thus, when the tow vehicle 100 tows the towed vehicle 200 to travel to the destination in a state in which the tow vehicle 100 and the towed vehicle 200 are connected by the connector 300, regenerative braking of a motor 201 mounted on the towed vehicle 200 may be performed, and a towing charging mode (referred to as an electric vehicle (EV) flat tow mode), in which power generated by the regenerative braking charges a high-voltage battery 203 through an inverter 202, may be executed.

In this case, a regenerative braking amount command signal may be transmitted from the vehicle controller of the tow vehicle 100 to the vehicle controller of the towed vehicle 200 through the cable for the CAN communication included in the connector 300, and information on a battery charging amount according to the regenerative braking may be transmitted from the vehicle controller of the towed vehicle 200 to the vehicle controller of the tow vehicle 100.

In this way, when the tow vehicle 100 tows the towed vehicle 200 and travels to the destination, the high-voltage battery 203 of the towed vehicle 200 is charged so that a battery charging time of the towed vehicle can be shortened, convenience of charging can be achieved, and battery power of the towed vehicle can be easily used after the tow vehicle 100 arrives at the destination.

However, when the connector 300 connected between the tow vehicle 100 and the towed vehicle 200 is damaged or bent due to an external force, there is a problem in that an abnormal phenomenon occurs in the cable included in the connector 300 (e.g., a phenomenon of a disconnection or error in an information transmission and reception signal necessary for driving).

Moreover, due to an abnormality in the cable included in the connector 300, the information transmission and reception necessary for driving between the vehicle controller of the tow vehicle 100 and the vehicle controller of the towed vehicle 200 becomes difficult so that it may not be possible to execute the above-described towing charging mode and a safety accident such as separation of the towed vehicle may occur.

### SUMMARY

The present disclosure has been made in an effort to solve the above-described problems associated with prior art.

In one aspect, the present disclosure provides a system and method for controlling a tow mode of an eco-friendly vehicle, which detects whether an abnormality occurs in a connector connected between a tow vehicle and a towed vehicle to enable towing and communication therebetween using various sensors, warns the driver of an abnormality in the connector based on the detection result, and induces an emergency stop of the vehicle through control that applies a braking torque to the towed vehicle in addition to the tow vehicle, thereby preventing a safety accident of the vehicle due to an abnormality in the connector in advance.

Objectives of the present disclosure are not limited to the above-described objectives, and other objectives of the present disclosure, which are not described, can be clearly understood to those skilled in the art (hereinafter, referred to as an “ordinary skilled in the art”) to which the present disclosure pertains from the following description.

In an embodiment, the present disclosure provides a system for controlling a tow mode of an eco-friendly vehicle, which includes a first vehicle controller mounted on a tow vehicle, a second vehicle controller mounted on a towed vehicle, a connector connected between the tow vehicle and the towed vehicle to enable towing and communication therebetween, and a warning device of the towed vehicle operated by a control signal of the second vehicle controller when interruption of a vehicle information signal for driving transmitted from the first vehicle controller to the second vehicle controller through the connector occurs for a certain period of time or longer.

According to one embodiment of the present disclosure, the warning device of the towed vehicle may include an emergency light of the towed vehicle operated by the control signal of the second vehicle controller, a headlight for turning a high beam on, and a horn.

The system for controlling a tow mode of an eco-friendly vehicle according to one embodiment of the present disclosure may further include a braking controller of the tow vehicle configured to apply a braking torque to a braking device of the tow vehicle when a vehicle speed does not reach zero for a certain period of time after the warning device of the towed vehicle is operated, and a braking controller of the towed vehicle configured to apply a braking torque to a braking device of the towed vehicle.

In an embodiment, the present disclosure provides a method of controlling a tow mode of an eco-friendly vehicle, which includes connecting a tow vehicle and a towed vehicle to enable towing and communication therebetween through a connector, transmitting a vehicle driving information signal from a first vehicle controller of the tow vehicle to a second vehicle controller of the towed vehicle through the connector, and when interruption of a vehicle information signal for driving transmitted from the first vehicle controller to the second vehicle controller through the connector occurs for a certain period of time or longer, operating a warning device of the towed vehicle by a control signal of the second vehicle controller.

According to one embodiment of the present disclosure, in the operating of the warning device of the towed vehicle, an emergency light of the towed vehicle may be turned on, a high beam of a headlight may be turned on, and a horn may be operated by the control signal of the second vehicle controller.

The method of controlling a tow mode of an eco-friendly vehicle according to one embodiment of the present disclosure may further include, after the warning device of the towed vehicle is operated and when a vehicle speed does not reach zero for a certain period of time, applying a braking torque to a braking device of the tow vehicle by a braking controller of the tow vehicle, and applying a braking torque to a braking device of the towed vehicle by a braking controller of the towed vehicle.

In another embodiment, the present disclosure provides a system for controlling a tow mode of an eco-friendly vehicle, which includes a first vehicle controller mounted on a tow vehicle, a first sensor group configured to detect vehicle information for driving of the tow vehicle and provide the vehicle information to the first vehicle controller, a second vehicle controller mounted on a towed vehicle, a second sensor group configured to detect vehicle information for driving of the towed vehicle and provide the vehicle information to the second vehicle controller, a connector connected between the tow vehicle and the towed vehicle to enable towing and communication therebetween, and a warning device of the towed vehicle operated by a control signal of the second vehicle controller when a difference value between the detection information of the first sensor group transmitted from the first vehicle controller to the second vehicle controller through the connector and the detection information of the second sensor group transmitted to the second vehicle controller is greater than or equal to a set value.

According to another embodiment of the present disclosure, the warning device of the towed vehicle may include an emergency light of the towed vehicle operated by the control signal of the second vehicle controller, a headlight for turning a high beam on, and a horn.

The first sensor group may include a wheel speed sensor, a steering angle sensor, and an acceleration sensor, which are mounted on the tow vehicle, and the second sensor group may include a wheel speed sensor, a steering angle sensor, and an acceleration sensor, which are mounted on the towed vehicle.

The system for controlling a tow mode of an eco-friendly vehicle according to another embodiment of the present disclosure may further include a braking controller of the tow vehicle configured to apply a braking torque to a braking device of the tow vehicle when a vehicle speed does not reach zero for a certain period of time after the warning device of the towed vehicle is operated, and a braking controller of the towed vehicle configured to apply a braking torque to a braking device of the towed vehicle.

In another embodiment, the present disclosure provides a method of controlling a tow mode of an eco-friendly vehicle, which includes connecting a tow vehicle and a towed vehicle to enable towing and communication therebetween through a connector, detecting, by a first sensor group of the tow vehicle and a second sensor group of the towed vehicle, vehicle information for driving, transmitting detection information of the first sensor group from the first vehicle controller of the tow vehicle to the second vehicle controller of the towed vehicle through the connector; comparing, by the second vehicle controller, a difference value between the detection information of the first sensor group and the detection information of the second sensor group, which are transmitted from the first vehicle controller to the second vehicle controller through the connector with a set value, and when the difference value between the detection information of the first sensor group and the detection information of the second sensor group is greater than or equal to the set value, operating a warning device of the towed vehicle by a control signal of the second vehicle controller.

According to another embodiment of the present disclosure, in the operating of the warning device of the towed vehicle, an emergency light of the towed vehicle may be turned on, a high beam of a headlight may be turned on, and a horn may be operated by the control signal of the second vehicle controller.

In the comparing of the difference value with the set value, when the difference value between a vehicle speed detected by a wheel speed sensor in the first sensor group and a vehicle speed detected by a wheel speed sensor in the second sensor group is greater than or equal to a set value, the connector may be determined to be in an abnormal state.

Alternatively, in the comparing of the difference value with the set value, when a difference value between a steering angle detected by a steering angle sensor of the first sensor group and a steering angle detected by a steering angle sensor of the second sensor group is greater than or equal to a set value, and a difference value between an acceleration detected by an acceleration sensor of the first sensor group and an acceleration detected by the acceleration sensor of the second sensor group is greater than or equal to a set value, the connector may be determined to be in an abnormal state.

The method of controlling a tow mode of an eco-friendly vehicle according to another embodiment of the present disclosure may further include, after the warning device of the towed vehicle is operated and when a vehicle speed does not reach zero for a certain period of time, applying a braking torque to a braking device of the tow vehicle by a braking controller of the tow vehicle, and applying a braking torque to a braking device of the towed vehicle by a braking controller of the towed vehicle.

Other aspects and preferred embodiments of the present disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram illustrating a conventional towing charging mode;

FIG. 2 is a control block diagram illustrating a system for controlling a tow mode of an eco-friendly vehicle according to one embodiment of the present disclosure;

FIG. 3 is a flowchart illustrating a method of controlling a tow mode of an eco-friendly vehicle according to one embodiment of the present disclosure;

FIG. 4 is a control block diagram illustrating a system for controlling a tow mode of an eco-friendly vehicle according to another embodiment of the present disclosure; and

FIG. 5 is a flowchart illustrating a method of controlling a tow mode of an eco-friendly vehicle according to another embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structures or functional descriptions present in embodiments of the present specification are merely exemplified for the purpose of describing the embodiments according to the concept of the present disclosure, and the embodiments according to the concept of the present disclosure may be implemented in various forms. In addition, the embodiments are not to be taken in a sense which limits the present disclosure to the specific embodiments, and should be construed to include all modifications, equivalents, or substitutes within the spirit and technical scope of the present disclosure.

The terms first, second, and/or the like in the present specification may be used to describe various components, but the components are not limited by these terms. These terms may be used only for the purpose of distinguishing one component from another component, and, for example, a first component may be referred to as a second element, and similarly, the second component may also be referred to as the first component without departing from the scope of the present disclosure.

In the present specification, when a component is referred to as being “connected” or “coupled” to another component, it may be directly connected or coupled to another component, but it should be understood that sill another component may be present between the component and another component. On the contrary, when a component is referred to as being “directly connected to,” or “directly in contact with” another component, it should be understood that still another component may not be present between the component and another component. Other expressions describing the relationship between components, that is, “between” and “immediately between,” or “adjacent to” and “directly adjacent to” should also be construed as described above.

The same reference numerals denote the same elements throughout the present specification. Terms used herein are intended to describe embodiments and are not intended to limit the present invention. In the present specification, the singular forms include the plural forms unless the context clearly dictates otherwise. It is noted that the terms “comprises” and/or “comprising” used herein does not exclude the presence or addition of one or more other components, steps, operations, and/or elements in addition to stated components, steps, operations, and/or elements.

Hereinafter, embodiments of the present disclosure will be described in detail with reference to the accompanying drawings.

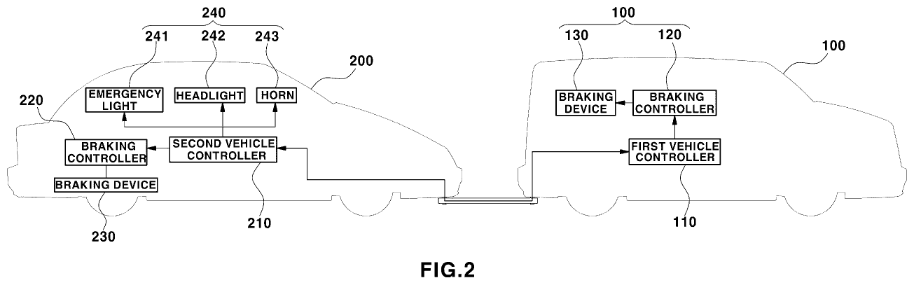

FIG. 2 is a control block diagram illustrating a system for controlling a tow mode of an eco-friendly vehicle according to one embodiment of the present disclosure.

As shown in FIG. 2, in order for a tow vehicle 100 to tow a towed vehicle 200 to a destination, the tow vehicle 100 and the towed vehicle 200 are connected to enable towing and communication therebetween through a connector 300.

To this end, the tow vehicle 100 and the towed vehicle 200 may be connected to enable towing and communication therebetween by the connector 300 including a cable for controller area network (CAN) communication, and a first vehicle controller 110 mounted on the tow vehicle 100 and a second vehicle controller 210 mounted on the towed vehicle 200 may be connected to enable vehicle information transmission and reception for driving by the cable for the CAN communication included in the connector 300.

Both the tow vehicle 100 and the towed vehicle 200 may be a hybrid vehicle, an electric vehicle (EV), or a fuel cell vehicle.

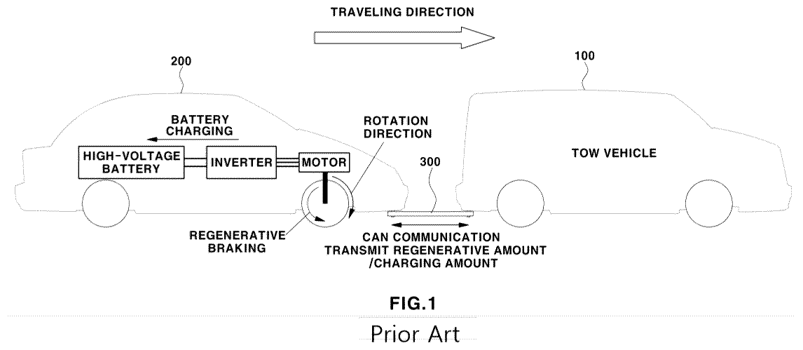

Thus, as described with reference to FIG. 1, when the tow vehicle 100 tows the towed vehicle 200 to travel to the destination in a state in which the tow vehicle 100 and the towed vehicle 200 are connected by the connector 300, regenerative braking of a motor 201 mounted on the towed vehicle 200 may be performed, and a towing charging mode, in which power generated by the regenerative braking charges a high-voltage battery 203 through an inverter 202, may be executed.

In this case, a regenerative braking amount command signal may be transmitted from the first vehicle controller 110 of the tow vehicle 100 to the second vehicle controller 210 of the towed vehicle 200 through the cable for the CAN communication included in the connector 300, and information on a battery charging amount according to the regenerative braking may be transmitted from the second vehicle controller 210 of the towed vehicle 200 to the first vehicle controller 110 of the tow vehicle 100.

However, when an abnormality occurs in the cable included in the connector 300, the vehicle information transmission and reception necessary for driving between the first vehicle controller 110 of the tow vehicle 100 and the second vehicle controller 210 of the towed vehicle 200 becomes difficult so that it may not be possible to execute the above-described towing charging mode and a safety accident such as separation of the towed vehicle may occur.

In order to solve this problem, the present disclosure focused on detecting whether an abnormality occurs in the connector 300 that is connected to enable towing and communication between the tow vehicle 100 and the towed vehicle 200, and when it is determined that the abnormality occurs in the connector 300 as the detection result, providing a driver warning for notifying the occurrence of the connector abnormality, and inducing emergency stops of the vehicle.

To this end, since communication modules (e.g., CAN communication modules) are embedded in the first vehicle controller 110 of the tow vehicle 100 and the second vehicle controller 210 of the towed vehicle 200, the first vehicle controller 110 and the second vehicle controller 210 may be connected to each other to be able to communicate with each other.

For example, since the tow vehicle 100 and the towed vehicle 200 are connected to enable towing and communication by the connector 300 including a cable capable of CAN communication, the first vehicle controller 110 and the second vehicle controller 210 may be communicatively connected to each other by the connector 300.

In addition, when a vehicle information signal for driving is received from the first vehicle controller 110 to the second vehicle controller 210 through the connector 300, the second vehicle controller 210 checks whether the vehicle information signal is received without interruption.

In addition, when an interruption occurs in the vehicle information signal for driving transmitted from the first vehicle controller 110 to the second vehicle controller 210 through the connector 300, the second vehicle controller 210 controls to operate a warning device 240 of the towed vehicle 200.

In this case, the warning device 240 of the towed vehicle 200 provides a visual and auditory warning to the driver riding in the towed vehicle 100 in order to induce an emergency stop of the vehicle due to an abnormality occurrence of the connector and may include an emergency light 241 of the towed vehicle operated by a control signal of the second vehicle controller 210, a headlight 242 for turning a high beam on, and a horn 243.

In addition, the system for controlling a tow mode of an eco-friendly vehicle according to one embodiment of the present disclosure may further include, after the warning device 240 of the towed vehicle 200 is activated and when a vehicle speed does not reach zero for a certain period of time, a braking controller 120 of the tow vehicle 100 configured to apply a braking torque to a braking device 130 of the tow vehicle 100 in order to perform an emergency stop of the vehicle due to the abnormality occurrence of the connector, and a braking controller 220 of the towed vehicle 200 configured to apply a braking torque to a braking device 230 of the towed vehicle 200.

Here, a method of controlling a tow mode of an eco-friendly vehicle according to one embodiment of the present disclosure will be described as follows.

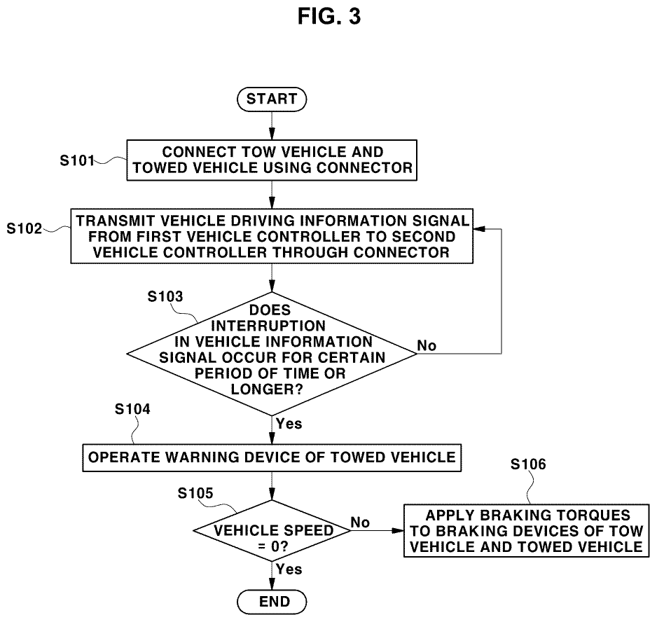

FIG. 3 is a flowchart illustrating the method of controlling a tow mode of an eco-friendly vehicle according to one embodiment of the present disclosure.

First, in order to activate the towing charging mode (EV flat tow mode), the tow vehicle 100 and the towed vehicle 200 are connected to enable towing and communication therebetween using the connector 300 including a CAN communication line (S101).

Thus, when the tow vehicle 100 tows the towed vehicle 200 and travels to the destination, the vehicle driving information signal may be transmitted from the first vehicle controller 110 of the tow vehicle 100 to the second vehicle controller 210 of the towed vehicle 200 through the connector 300 (S102).

Next, the second vehicle controller 210 determines whether interruption occurs in a vehicle information signal for driving transmitted from the first vehicle controller 110 to the second vehicle controller 210 through the connector 300 for a certain period of time or longer (S103).

When the interruption occurs in the vehicle information signal for a certain period of time or longer as the determination result in operation S103, the second vehicle controller 210 determines that an abnormality occurs in the connector 300, and the warning device 240 of the towed vehicle 200 is operated by the control signal of the second vehicle controller 210 to warn the driver of the abnormality occurrence (S104).

In this case, as the warning device 240 operated by the control signal of the second vehicle controller 210, the emergency light 241 of the towed vehicle may be turned on, a high beam of the headlight 242 of the towed vehicle may be turned on, and the horn 243 of the towed vehicle may be operated.

Thus, a visual warning is provided to the driver riding in the tow vehicle 100 by turning the emergency light 241 and the high beam of the headlight 242 on, and an auditory warning is provided by operating the horn 243, thereby inducing the driver to perform an emergency stop of the vehicle due to the abnormality occurrence of the connector 300.

Subsequently, after the warning device 240 of the towed vehicle 200 is operated, it is determined whether a vehicle speed becomes zero for a certain period of time (S105).

For example, the first vehicle controller 110 and the second vehicle controller 210 may respectively determine whether the vehicle speed becomes zero based on a vehicle speed sensor detection signal of the tow vehicle and a vehicle speed sensor detection signal of the towed vehicle, and when the vehicle speed is zero, it can be determined that the emergency stop of the vehicle is performed due to the abnormality occurrence of the connector 300 by the driver.

When it is determined that the vehicle speed does not reach zero for a certain period of time after the warning device 240 of the towed vehicle 200 is operated, an operation in which a braking torque is applied to the braking device 130 of the tow vehicle 100 under the control of the braking controller 120 according to a command of the first vehicle controller 110 of the tow vehicle 100 and a braking torque is applied to the braking device 230 of the towed vehicle 200 under the control of the braking controller 220 according to a command of the second vehicle controller 210 of the towed vehicle 200 (S106) may be performed.

Therefore, when the vehicle speed does not reach zero for a certain period of time after the driver is first warned visually and audibly that the abnormality occurs in the connector 300, by inducing the emergency stop of the vehicle through the control of applying the braking torque to the towed vehicle in addition to the tow vehicle, safety accidents of the vehicle due to the abnormality occurrence in the connector can be prevented in advance.

Here, a configuration of a system for controlling a tow mode of an eco-friendly vehicle according to another embodiment of the present disclosure will be described as follows.

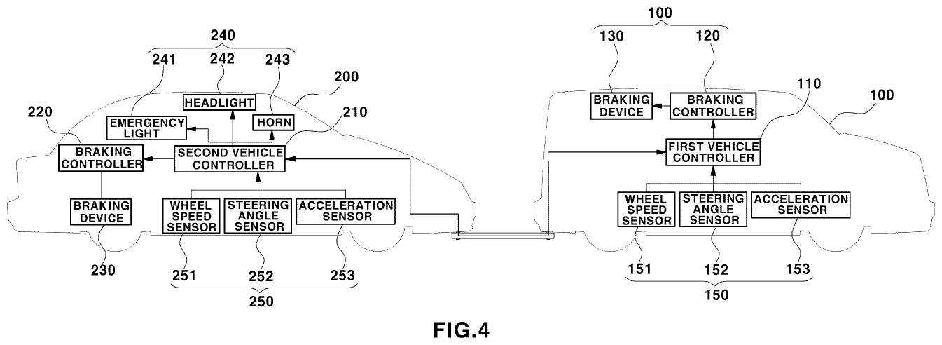

FIG. 4 is a control block diagram illustrating a system for controlling a tow mode of an eco-friendly vehicle according to another embodiment of the present disclosure.

As shown in FIG. 4, in order for a tow vehicle 100 to tow a towed vehicle 200 to a destination, the tow vehicle 100 and the towed vehicle 200 are connected to enable towing and communication therebetween through a connector 300.

A first vehicle controller 110 mounted on the tow vehicle 100 and a second vehicle controller 210 mounted on the towed vehicle 200 are connected to enable vehicle information transmission and reception for driving by a cable for CAN communication included in the connector 300.

The system for controlling a tow mode of an eco-friendly vehicle according to another embodiment of the present disclosure includes a first sensor group 150 configured to detect vehicle information for driving of the tow vehicle 100 and provide the vehicle information to the first vehicle controller 110, and a second sensor group 250 configured to detect vehicle information for driving of the towed vehicle 200 and provide the vehicle information to the second vehicle controller 210.

In this case, the first sensor group 150 may include a wheel speed sensor 151, a steering angle sensor 152, and an acceleration sensor 153, which are mounted on the tow vehicle 100, and the second sensor group 250 may include a wheel speed sensor 251, a steering angle sensor 252, and an acceleration sensor 253, which are mounted on the towed vehicle 200.

In particular, when a difference between detection information of the first sensor group 150 transmitted from the first vehicle controller 110 to the second vehicle controller 210 through the connector 300 and detection information of the second sensor group 250 transmitted to the second vehicle controller 210 is greater than or equal to a set value, the second vehicle controller 210 determines that an abnormality occurs in the connector 300 and controls to operate a warning device 240 of the towed vehicle 200.

For example, when a difference between a vehicle speed detected by the wheel speed sensor 151 of the first sensor group 150 of the tow vehicle 100 and a vehicle speed detected by the wheel speed sensor 251 of the second sensor group 250 of the towed vehicle 200 is greater than or equal to a set value, the second vehicle controller 210 may determine that the connector 300 is in an abnormal state.

Alternatively, when a difference between a steering angle detected by the steering angle sensor 152 of the first sensor group 150 of the tow vehicle 100 and a steering angle detected by the steering angle sensor 252 of the second sensor group 250 of the towed vehicle 200 is greater than or equal to a set value and a difference between an acceleration detected by the acceleration sensor 153 of the first sensor group 150 and an acceleration detected by the acceleration sensor 253 of the second sensor group 250 is greater than or equal to a set value, the second vehicle controller 210 may determine that the connector 300 is in an abnormal state.

Preferably, the set values may be set in advance in consideration that a slight difference in vehicle speed may occur between the tow vehicle 100 and the towed vehicle 200 or a slight difference in steering angle and acceleration may occur between the tow vehicle 100 and the towed vehicle 200 due to a difference in road surface or driving environment.

Similar to the above-described embodiment, a warning device 240 of the towed vehicle 200 is to provide a visual and auditory warning to the driver riding in the towed vehicle 100 in order to induce an emergency stop of the vehicle due to an abnormality occurrence of the connector and may include an emergency light 241 of the towed vehicle operated by a control signal of the second vehicle controller 210, a headlight 242 for turning a high beam on, and a horn 243.

Similar to the above-described embodiment, the system for controlling a tow mode of an eco-friendly vehicle according to another embodiment of the present disclosure may further include, after the warning device 240 of the towed vehicle 200 is activated and when a vehicle speed does not reach zero for a certain period of time, a braking controller 120 of the tow vehicle 100 configured to apply a braking torque to a braking device 130 of the tow vehicle 100 in order to perform an emergency stop of the vehicle due to the abnormality occurrence of the connector, and a braking controller 220 of the towed vehicle 200 configured to apply a braking torque to a braking device 230 of the towed vehicle 200.

Here, a method of controlling a tow mode of an eco-friendly vehicle according to another embodiment of the present disclosure will be described as follows.

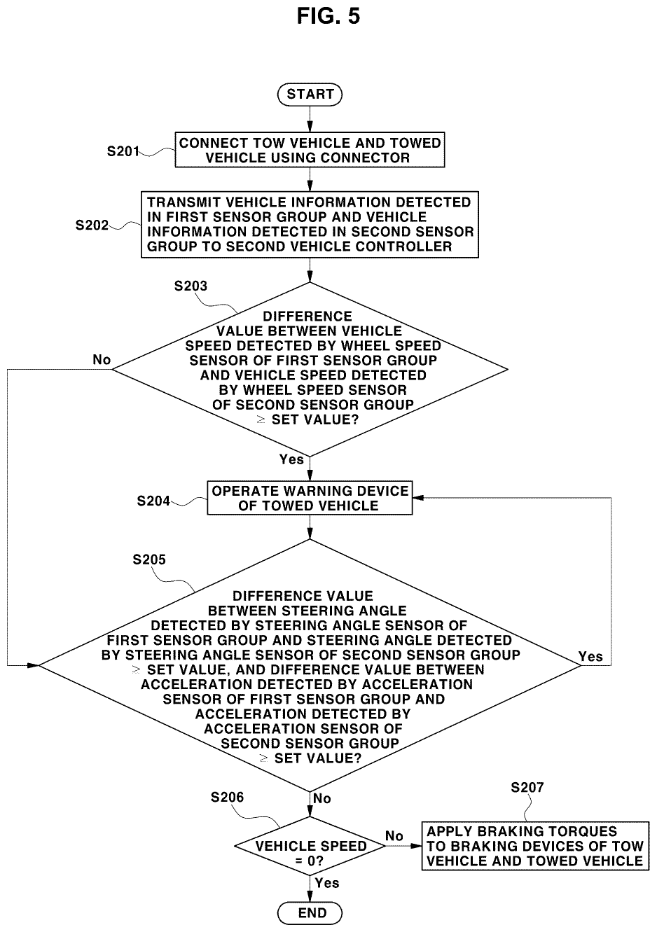

FIG. 5 is a flowchart illustrating a method of controlling a tow mode of an eco-friendly vehicle according to another embodiment of the present disclosure.

First, in order to activate the towing charging mode (EV flat tow mode), the tow vehicle 100 and the towed vehicle 200 are connected to enable towing and communication therebetween using the connector 300 including a CAN communication line (S201).

Thus, when the tow vehicle 100 tows the towed vehicle 200 and travels to a destination, vehicle information for driving detected in the first sensor group 150 of the tow vehicle 100 and vehicle information for driving detected in the second sensor group 250 of the towed vehicle 200 are transmitted to the second vehicle controller 210 (S202).

In other words, when the tow vehicle 100 tows the towed vehicle 200 and travels to the destination, the vehicle information for driving detected in the first sensor group 150 of the tow vehicle 100 may be transmitted to the first vehicle controller 110 and then transmitted from the first vehicle controller 110 to the second vehicle controller 210 of the towed vehicle 200 through the connector 300, and the vehicle information for driving detected in the second sensor group 250 of the towed vehicle 200 may be transmitted to the second vehicle controller 210.

For example, a vehicle speed detected by the wheel speed sensor 151 constituting the first sensor group 150, a steering angle detected by the steering angle sensor 152, and an acceleration detected by the acceleration sensor 153 may be transmitted from the first vehicle controller 110 to the second vehicle controller 210 of the towed vehicle 200 through the connector 300, and a vehicle speed detected by the wheel speed sensor 251 constituting the second sensor group 250, a steering angle detected by the steering angle sensor 252, and an acceleration detected by the acceleration sensor 253 may be transmitted to the second vehicle controller 210 of the towed vehicle 200.

Thus, the second vehicle controller 210 may compare a difference value between detection information of the first sensor group 150 and detection information of the second sensor group 250, which are transmitted from the first vehicle controller 110 to the second vehicle controller 210 through the connector, with a set value, and when the difference value between the detection information of the first sensor group 150 and the detection information of the second sensor group 250 is greater than or equal to the set value as the comparison result, the second vehicle controller 210 may determine that the connector 300 is in an abnormal state and the warning device 240 of the towed vehicle 200 may be operated by a control signal of the second vehicle controller 210.

To this end, first, the second vehicle controller 210 compares a difference value between a vehicle speed detected by the wheel speed sensor 151 of the first sensor group 150 and a vehicle speed detected by the wheel speed sensor 251 of the second sensor group 250 with a set value (S203), and when the difference value is greater than or equal to the set value as the comparison result, the second vehicle controller 210 determined that the connector 300 is in an abnormal state and controls to operate the warning device 240 of the towed vehicle 200 so that the warning device 240 of the towed vehicle 200 is operated (S204).

In this case, the operation of the warning device 240 by the control signal of the second vehicle controller in operation S204 is performed in combination with the turning the emergency lights of the vehicle on and the turning the high beam of the headlight on, and the operation of the horn so that the driver riding in the tow vehicle can easily recognize the operation of the warning device 240.

According to the comparison result in operation S203, when the difference value is less than the set value, the difference value between the steering angle detected by the steering angle sensor 152 of the first sensor group 150 and the steering angle detected by the steering angle sensor 252 of the second sensor group 250 is continuously compared with the set value, and the difference value between the acceleration detected by the acceleration sensor 153 of the first sensor group 150 and the acceleration detected by the acceleration sensor 253 of the second sensor group 250 is continuously compared with the set value (S205).

In addition to comparing the detected values of the wheel speed sensor 151 of the first sensor group 150 and the wheel speed sensor 251 of the second sensor group 250 in operation S203, the reason for continuously comparing the detected values of the steering angle sensors 152 and 252 and the detected values of the acceleration sensors 153 and 253 is to enable more precise determination of whether the connector 300 is abnormal.

When the difference value between the steering angle detected by the steering angle sensor 152 of the first sensor group 150 and the steering angle detected by the steering angle sensor 252 of the second sensor group 250 is greater than or equal to the set value, and when the difference value between the acceleration detected by the acceleration sensor 153 of the first sensor group 150 and the acceleration detected by the acceleration sensor 253 of the second sensor group 250 is greater than or equal to the set value, the connector is determined to be in an abnormality state, and the warning device 240 of the towed vehicle 200 is controlled to be operates so that the warning device 240 of the towed vehicle 200 is operated (S204).

Subsequently, after the warning device 240 of the towed vehicle 200 is operated, it is determined whether a vehicle speed becomes zero for a certain period of time (S206).

For example, the first vehicle controller 110 and the second vehicle controller 210 may respectively determine whether the vehicle speed becomes zero based on a vehicle speed sensor detection signal of the tow vehicle and a vehicle speed sensor detection signal of the towed vehicle, and when the vehicle speed is zero, it can be determined that the emergency stop of the vehicle is performed due to the abnormality occurrence of the connector 300 by the driver.

As the determination result in operation S206, when it is determined that the vehicle speed does not reach zero for a certain period of time after the warning device 240 of the towed vehicle 200 is operated, an operation in which a braking torque is applied to the braking device 130 of the tow vehicle 100 under the control of the braking controller 120 according to a command of the first vehicle controller 110 of the tow vehicle 100 and a braking torque is applied to the braking device 230 of the towed vehicle 200 under the control of the braking controller 220 according to a command of the second vehicle controller 210 of the towed vehicle 200 (S207) may be performed.

Therefore, when the vehicle speed does not reach zero for a certain period of time after the driver is first warned visually and audibly that the abnormality occurs in the connector 300, by inducing the emergency stop of the vehicle through the control of applying the braking torque to the towed vehicle in addition to the tow vehicle, safety accidents of the vehicle due to the abnormality occurrence in the connector can be prevented in advance.

The present disclosure provides the following effects through the above-described problem solving means.

First, whether an abnormality occurs in a connector that is connected to enable towing and communication between a tow vehicle and a towed vehicle is detected, visual and auditory warning are first provided to a driver that there is the abnormality occurs in the connector based on the detection result so that an emergency stop of the vehicle due to the abnormality occurrence in the connector can be induced.

Second, when the vehicle speed does not reach zero for a certain period of time after the driver is first warned visually and audibly that the abnormality occurs in the connector, by inducing the emergency stop of the vehicle through the control of applying the braking torque to the towed vehicle in addition to the tow vehicle, safety accidents of the vehicle due to the abnormality occurrence in the connector can be prevented in advance.

Although the embodiments of the present disclosure have been described in detail, the scope of the prevent disclosure is not limited to these embodiments, and various modifications and improvements devised by those skilled in the art using the fundamental concept of the present disclosure, which is defined by the appended claims, may further fall within the scope of the present disclosure.

1. A system for controlling a tow mode of an eco-friendly vehicle, the system comprising:
a first vehicle controller mounted on a tow vehicle;
a second vehicle controller mounted on a towed vehicle; and
a connector connected between the tow vehicle and the towed vehicle, and configured to enable towing and communication between the tow vehicle and the towed vehicle;
wherein the towed vehicle comprises a warning device configured to be operated by the second vehicle controller when interruption of a vehicle information signal for driving transmitted from the first vehicle controller to the second vehicle controller through the connector occurs for a certain period of time or longer.

2. The system of claim 1, wherein the warning device includes an emergency light operated by the second vehicle controller, a headlight for operating a high beam, and a horn.

3. The system of claim 1, wherein the tow vehicle further comprises a braking controller configured to apply a braking torque to a braking device of the tow vehicle when a vehicle speed does not reach zero for a certain period of time after the warning device of the towed vehicle is operated, and wherein the towed vehicle further comprises a braking controller configured to apply a braking torque to a braking device of the towed vehicle.

4. A method of controlling a tow mode of an eco-friendly vehicle, the method comprising:
connecting a tow vehicle to a towed vehicle to enable towing and communication between the tow vehicle and the towed vehicle through a connector;
transmitting a vehicle driving information signal from a first vehicle controller of the tow vehicle to a second vehicle controller of the towed vehicle through the connector; and
when interruption of a vehicle information signal for driving transmitted from the first vehicle controller to the second vehicle controller through the connector occurs for a certain period of time or longer, operating a warning device of the towed vehicle by a control signal of the second vehicle controller.

5. The method of claim 4, wherein, operating the warning device of the towed vehicle comprises:
turning on an emergency light of the towed vehicle;
turning on a high beam of a headlight; and
operating a horn by the control signal of the second vehicle controller.

6. The method of claim 4, further comprising:
after the warning device of the towed vehicle is operated, and when a vehicle speed does not reach zero for a certain period of time, applying a braking torque to a braking device of the tow vehicle by a braking controller of the tow vehicle, and applying a braking torque to a braking device of the towed vehicle by a braking controller of the towed vehicle.

7. A system for controlling a tow mode of an eco-friendly vehicle, the system comprising:
a first vehicle controller mounted on a tow vehicle;
a first sensor group configured to detect vehicle information for driving of the tow vehicle, and to provide the vehicle information to the first vehicle controller;
a second vehicle controller mounted on a towed vehicle;
a second sensor group configured to detect vehicle information for driving of the towed vehicle, and to provide the vehicle information to the second vehicle controller; and
a connector connected between the tow vehicle and the towed vehicle, and configured to enable towing and communication between the tow vehicle and the towed vehicle;
wherein the towed vehicle comprises a warning device operated by the second vehicle controller when a difference value between the detection information of the first sensor group transmitted from the first vehicle controller to the second vehicle controller through the connector and the detection information of the second sensor group transmitted to the second vehicle controller is greater than or equal to a set value.

8. The system of claim 7, wherein the warning device includes an emergency light operated by the second vehicle controller, a headlight for operating a high beam, and a horn.

9. The system of claim 7, wherein the first sensor group includes a wheel speed sensor, a steering angle sensor, and an acceleration sensor, each being mounted on the tow vehicle, and the second sensor group includes a wheel speed sensor, a steering angle sensor, and an acceleration sensor, each being mounted on the towed vehicle.

10. The system of claim 9, wherein when a difference value between a vehicle speed detected by the wheel speed sensor in the first sensor group and a vehicle speed detected by the wheel speed sensor in the second sensor group is greater than or equal to the set value, the connector is determined to be in an abnormal state.

11. The system of claim 9, wherein when a difference value between a steering angle detected by the steering angle sensor of the first sensor group and a steering angle detected by the steering angle sensor of the second sensor group is greater than or equal to the set value, and a difference value between an acceleration detected by the acceleration sensor of the first sensor group and the acceleration detected by the acceleration sensor of the second sensor group is greater than or equal to the set value, the connector is determined to be in an abnormal state.

12. The system of claim 7, wherein the tow vehicle further comprises a braking controller configured to apply a braking torque to a braking device of the tow vehicle when a vehicle speed does not reach zero for a certain period of time after the warning device of the towed vehicle is operated, and the towed vehicle further comprises a braking controller configured to apply a braking torque to a braking device of the towed vehicle.

13. A method of controlling a tow mode of an eco-friendly vehicle, the method comprising:
connecting a tow vehicle and a towed vehicle to enable towing and communication between the tow vehicle and the towed vehicle through a connector;
detecting, by a first sensor group of the tow vehicle and a second sensor group of the towed vehicle, vehicle information for driving;
transmitting detection information of the first sensor group from a first vehicle controller of the tow vehicle to a second vehicle controller of the towed vehicle through the connector;
comparing, by the second vehicle controller, a difference value between the detection information of the first sensor group and the detection information of the second sensor group, which are transmitted from the first vehicle controller to the second vehicle controller through the connector with a set value; and
when the difference value between the detection information of the first sensor group and the detection information of the second sensor group is greater than or equal to the set value, operating a warning device of the towed vehicle by a control signal of the second vehicle controller.

14. The method of claim 13, wherein, operating the warning device of the towed vehicle comprises turning on an emergency light of the towed vehicle, turning on a high beam of a headlight, and operating a horn by the control signal of the second vehicle controller.

15. The method of claim 13, wherein, during comparing the difference value with the set value, when the difference value between a vehicle speed detected by a wheel speed sensor in the first sensor group and a vehicle speed detected by a wheel speed sensor in the second sensor group is greater than or equal to a set value, the connector is determined to be in an abnormal state.

16. The method of claim 13, wherein, during comparing of the difference value with the set value, when a difference value between a steering angle detected by a steering angle sensor of the first sensor group and a steering angle detected by a steering angle sensor of the second sensor group is greater than or equal to a set value, and a difference value between an acceleration detected by an acceleration sensor of the first sensor group and an acceleration detected by the acceleration sensor of the second sensor group is greater than or equal to a set value, the connector is determined to be in an abnormal state.

17. The method of claim 13, further comprising:
after the warning device of the towed vehicle is operated and when a vehicle speed does not reach zero for a certain period of time, applying a braking torque to a braking device of the tow vehicle by a braking controller of the tow vehicle, and applying a braking torque to a braking device of the towed vehicle by a braking controller of the towed vehicle.
